(19) United States
(12) Patent Application Publication
(10) Pub. No.: US 2002/0098451 A1
(43) Pub. Date: Jul. 25, 2002

(54) Photothermographic material

(76) Inventors: Tadashi Arimoto, Tokyo (JP); Takayuki Sasaki, Tokyo (JP); Eiichi Ueda, Tokyo (JP); Akihisa Nakajima, Tokyo (JP); Chiaki Nagaike, Tokyo (JP)

Correspondence Address: Squire, Sanders & Dempsey L.L.P., Suite 300, One Maritime Plaza, San Francisco, CA, 94111, US

(21) Appl. No.: 09/949,133

(22) Filed: Sep. 6, 2001

(30) Foreign Application Priority Data
Sep. 7, 2000 (JP) 2000-271349

(51) Int. Cl. G03C 1/795; G03C 1/498

(52) U.S. Cl. 430/531; 430/533; 430/350; 430/617; 430/620

(57) ABSTRACT

A photothermographic material is disclosed, comprising a support having thereon at least an image forming layer and a first layer on the opposite side of the support from the image forming layer, wherein the first layer contains a vinyl type polymer latex and an aqueous-dispersible polymer selected from the group consisting of an aqueous-dispersible polyester, aqueous-dispersible polyurethane and aqueous-disperible cellulose.

### FIELD OF THE INVENTION

The present invention related to photothermographic materials and in particular to photothermographic materials having a sublayer exhibiting superior photographic performance and improved adhesion property even after being preserved over a long period of time without being exposed to light.

### BACKGROUND OF THE INVENTION

In view of the social situation that concerns for environment are strongly required, wet process of silver halide photographic materials have come up to the present, while overcoming problems such as reduction of effluents. To minimize processing effluents, for example, reduction of the replenishing rate, solidification of processing chemicals and recycling of processing solutions have been attempted to overcome such problems. Silver halide photographic materials suitable to dry process instead of wet process have been developed under such an environment. For example, a thermally developable photothermographic material comprising silver halide, a reducing agent and a fatty acid silver salt, so-called dry silver, which is effluent-free are employed in some commercial areas of silver halide photographic materials.

The foregoing photothermographic material, after being exposed, is capable of being developed without using any processing solution and easily handled. However, this type photothermographic material is processed at a relatively high temperature, producing problems unexpected in conventional wet processing type photographic materials. For example, the photothermographic material tend to cause increased fogging when being preserved, before being exposed, over a long period of time. Further, there were produced problems that when subjected to thermal processing at a relatively high temperature, a backing layer provided on the opposite side of a support was peeled from the support, leading to serious troubles in development of the photothermographic material.

### SUMMARY OF THE INVENTION

Accordingly, it is an object of the present invention to provide photothermographic material having a sublayer exhibiting superior photographic performance even after aged, before exposed, over a long period of time and improved adhesion between the support and backing layer.

The foregoing object of the invention can be accomplished by the following constitution.

1. A photothermographic material comprising a support having thereon at least an image forming layer and a first layer on the opposite side of the support from the image forming layer, wherein the first layer contains an aqueous-dispersible polymer selected from the group consisting of an aqueous-dispersible polyester, aqueous-dispersible polyurethane and aqueous-dispersible cellulose, and a vinyl type polymer latex;

2. A photothermographic material comprising a polyester support having thereon at least an image forming layer and a first layer on the opposite side of the support from the image forming layer, wherein the first layer is formed by coating a composition obtained through latex polymerization of a vinyl type monomer in the presence of an aqueous-dispersible polymer selected from the group consisting of an aqueous-dispersible polyester, aqueous-dispersible polyurethane and aqueous-dispersible cellulose.

### DETAILED DESCRIPTION OF THE INVENTION

One aspect of the invention concerns the photothermographic material comprising a support having thereon at least an image forming layer and a first layer on the opposite side of the support from the image forming layer, in which the first layer contains an aqueous-dispersible polymer selected from the group consisting of an aqueous-dispersible polyester, aqueous-dispersible polyurethane and aqueous-dispersible cellulose, and a vinyl type polymer latex, thereby exhibiting stable photographic performance even when aged over a long period of time and improved adhesion to the support or a backing layer. In the invention, the foregoing aqueous-dispersible polymer is preferably contained in a sublayer, and more preferably in a sublayer adjacent to the backing layer.

The sublayer relating to the invention refers to all of the layer(s) provided between the support and the backing layer. The sublayer may be comprised of a single layer or two or more layers.

In the invention, the expression, aqueous-dispersible means being soluble in hot water at a temperature of 90° C. or higher or being dispersible in water in the form of dispersing particles having a number-averaged particle size of not more than 200 nm through emulsification. The aqueous-dispersible polyester is a substantially linear polyester obtained by allowing a polybasic acid or its ester and a polyol to undergo polycondensation, in which a component containing a hydrophilic group such as a sulfonate-containing component, a diethylene glycol component, a polyalkylene ether glycol component and a polyether dicarboxylic acid component, for example, are introduced as copolymerazing components to enhance water-solubility. A sulfonate-containing dicarboxylic acid is preferably used as a component containing a hydrophilic group (hereinafter, a dicarboxylic acid is also denoted as a polybasic acid).

Examples of the polybasic acid component include terephthalic acid, isophthalic acid, phthalic acid, 2,6-naphthalene-dicarboxylic acid, 1,4-cyclohexane-dicarboxylic acid, adipinic acid, sebacic acid, trimellitic acid, pyromellitic acid, dimeric acid, maleic acid, fumaric acid, itaconic acid, p-hydroxybenzoic acid, and p-(β-hydroxyethoxy)bebazoic acid. The sulfonate-containing dicarboxylic acids preferably are those containing an alkali sulfonate group, including, for example, alkali meat salts of 4-sulfoisophthalic acid, 5-sulfoisopthalic acid, sulfophthalic acid4-sulfonaphthalene-2,7-dicarboxylic acid and 5-(4-sulfophenoxy)isophthalic acid. Of these, 5-sodium-sulfoisophthalic acid (or sodium isophthalic-acid-5-sulfonate) is specifically preferred. This sulfonate-containing dicarboxylic acid is contained preferably in an amount of 5 to 15 mol %, and more preferably 6 to 10 mol % in terms of water-solubility and water resistance.

The aqueous-dispersible polyester preferably comprises terephthalic acid and isophthalic acid as main dicarboxylic acid components and the molar ratio of terephthalic acid/isophthalic acid is 30/70 to 70/30 in terms of coating-ability onto the polyester support and solubility in water. The phthalic acid component and isophthalic acid component is preferably contained in an amount of 50 to 80 mol %, based on the total dicarboylic acid component. Further, an aliphatic dicarboxylic acid is preferably used as a copolymerizing component. Examples of the aliphatic dicarboxylic acid include 1,4-cyclohexane-dicarboxylic acid, 1,3-cyclohexane-dicarboxylic acid, 1,2-cyclohexane-dicarboxylic acid, 1,3-cyclopentane-dicarboxylic acid, and 4,4′-bicyclohexyl-dicarboxylic acid. In aqueous-dispersible polyester mainly comprising phthalic acid and isophthalic acid as dicarboxylic acid components, other carboxylic acid(s) may be used as a copolymerizing component. Examples of such a dicarboxylic acid include aromatic dicarboxylic acids and straight chain aliphatic dicarboxylic acids. The aromatic dicarboxylic acid preferably used in an amount of not more than 30 mol %, based on total dicarboxylic acids. Examples of the aromatic dicarboxylic acid component include phthalic acid, 2,5-dimethylterephthalic acid, 2,6-naphthalene-dicarboxylic acid, 1,4-naphthalenedicarboxylic acid, and biphenyl-dicarboxylic acid. The straight chain aliphatic dicarboxylic acid is used preferably in an amount of not more than 15 mol %. Examples of the straight chain aliphatic dicarboxylic acid include adipinic acid, pimelic acid, azelaic acid, and sebacic acid.

Examples of the polyols component include ethylene glycol, diethylene glycol, 1,4-butane-diol, neopentyl glycol, dipropylene glycol, 1,6-hexanediol, 1,4-cyclohexane-dimethanol.xylene glycol, tromethylol propane, poly(ethylene oxide)glycol and poly(tetramethylene oxide)glycol. It is preferred to use ethylene glycol as a glycol component in an amount of not les than 50 mol %, based on total glycol components.

Aqueous-dispersible polyesters relating to the invention can be synthesized using dicarboxylic acid or its ester and glycol or its ester-forming derivative, by various methods. For example, it can be synthesized in commonly known polyesterification that an initial condensate of dicarboxylic acid and glycol is formed through transesterification (ester interchange) or direct esterification, which is further subjected to melt polycondensation. Exemplarily, an ester of dicarboxylic acid (e.g., dicarboxylic acid dimethylester) and glycol are allowed to undergo transesterification (ester interchange) and after distilling methanol, the pressure is gradually reduced and polycondensation is carried out in high vacuo. Other examples thereof include a method in which a dicarboxylic acid and a glycol undergo esterification and after distilling produced water, the pressure is gradually reduced and polycondensation is carried out in high vacuo and a method in which a dicarboxylic acid ester and glycol undergo transesteification and after adding a dicarboxylic acid to carry out esterification, polycondensation is carried out in high vacuo. There can be employed compounds known as a transesterification catalyst and polycondensation catalyst. Examples of the transesterification catalyst include manganese acetate, calcium acetate and zinc acetate, and examples of the polycondensation catalyst include antimony trioxide, gemanium oxide, dibutyl tin oxide and titanium tetrabutoxide. Various conditions including polymerization and a catalyst are not specifically limited.

One feature of the invention concerns the use of a aqueous-dispersible polyester modified with a vinyl type monomer. The aqueous-dispersible polyester modified with a vinyl type monomer refers to a product obtained by allowing a vinyl type monomer to disperse to undergo polymerization in an aqueous solution of the aqueous-dispersible polyester. For example, aqueous-dispersible polyester is dissolved in hot water and in the thus obtained aqueous polyester solution, a vinyl monomer is dispersed to undergo emulsion polymerization or suspension polymerization. Polymerization is preferably emulsion polymerization.

In polymerization, initiators are used, such as ammonium persulfate, potassium persulfate, sodium persulfate and benzoyl peroxide. Of these initiators, ammonium persulfate is preferred. Polymerization can be carried out without the use of a surfactant but a surfactant may be used as an emulsifying agent to enhance polymerization stability. In such a case, any of nonionic and anionic surfactants can be used.

Examples of vinyl monomers include acryl type monomers such as alkyl acrylate and alkyl methacrylate (in which examples of the alkyl group include methyl, ethyl, n-propyl, isopropyl, n-butyl, isobutyl, t-butyl, 2-ethylhexyl, cyclohexyl, benzyl, phenylethyl); hydroxy-containing monomer such as 2-hydroxyethyl acrylate, 2-hydroxyethyl methacrylate, 2-hydroxypropyl acrylate and 2-hydroxypropyl methacrylate; amide-containing monomer such as acrylamide, methacrylamide, N-methylmethacrylamide, N-methylacrylamide, N-methylol acrylamide, N,N-dimethylol acrylamide, N-methoxymethyl acrylamide, N-methoxymethyl methacrylamide and N-phenyl acrylamide; amino-containing monomer such as N,N-diethylaminoethyl acrylate, and N,N-diethylaminoethyl methacrylate; expoxy-containing monomer such as glycidyl acrylate and glycidyl methacrylate; and carboxy ot its salt-containing monomer such as acrylic acid, methacrylic acid and their salts (e.g., sodium salt, potassium salt, ammonium salt). Examples of monomers other then acryl type monomers include epoxy group-containing monomer such as allyl glycidyl ether; sulfonic acid group or its salt containing monomer such as styrenesulfonic acid, vinylsulfonic acid and their salts (e.g., sodium salt, potassium salt, ammonium salt); carboxy group or its salt containing monomer such as crotonic acid, itaconic acid, maleic acid, fumaric acid and their salts (e.g., sodium salt, potassium salt, ammonium salt); acid anhydride containing monomer, such as maleic acid anhydride and itaconic acid anhydride; vinyl isocyanate; allyl isocyanate; styrene; vinyl trisalkoxysilane; alkylmaleic acid monoester; alkylfumaric acid monoester; acrylonitrile; methcrylonitrile; alkylitaconic acid monoester; vinylidene chloride, vinyl acetate; and vinyl chloride. Of these are, glycidyl acrylate or glycidyl methacrylate is preferred in terms of coated layer strength.

With regard to the amount of vinyl monomers, the weight ratio of (aqueous-dispersible polymer)/(vinyl monomer) is preferably within the range of 99/1 to 5/95, more preferably 97/3 to 50/50, and still more preferably 95/5 to 80/20.

In the invention, the vinyl type polymer latex is referred to as water-insoluble hydrophobic polymer dispersed in water or aqueous medium in the form of fine particles. Thus, a vinyl type polymer is dispersed in such a form as the polymer is emulsified in a dispersing medium, the polymer is obtained through emulsion polymerization, the polymer is dispersed in the form of a micelle dispersion, or the polymer partially has a hydrophilic structure and its molecular chain being dispersed in a molecular form. Polymer latexes are described in Okuda “GOSEIJUSHI-EMULSION (Synthetic Resin Emulsion)” published by KOBUNSHI KANKOKAI (1978); Sugimura, Kataoka, Suzuki & Kasahara “GOSEI-LATEX NO OYO (Application of Synthetic Emulsion)” published by KOBUNSHI KANKOKAI (1993); Muroi “GOSEI-LATEX NO KAGAKU (Chemistry of Synthetic Latex)” published by KOBUNSHI KANKOKAI (1970). The average size of dispersing particles is 1 to 50,000 nm, and preferably 5 to 1,000 nm. Particle size distribution is not specifically limited and may be either poly-disperse or mono-disperse distribution.

The vinyl type polymer latex may be not only conventional uniform type but also a core/shell type, in which the core and shell are preferably different in glass transition temperature. The minimum film-forming temperature (MFT) of the vinyl type polymer latex is preferably −30° C. to 90° C., and more preferably 0° C. to 70° C. There may be added a film-forming aid to control the minimum film-forming temperature. Film-forming aids, which are also called a plasticizer are organic compounds capable of lowering the minimum film-forming temperature of the latex (which are usually organic solvents), as described in Muroi “GOSEI-LATEX NO KAGAKU (Chemistry of Synthetic Latex)” published by KOBUNSHI KANKOKAI (1970). As a component constituting a vinyl type polymer latex, vinyl type monomers described above are usable. As to the amount of a vinyl type monomer to be used, a ratio by weight of (aqueous-dispersible polymer)/(vinyl type monomer constituting a vinyl type polymer latex) is preferably within a range of 99/1 to 5/95, more preferably 97/3 to 50/50, and still more preferably 95/5 to 80/20.

Vinyl type polymer latexes usable in the invention can be prepared through emulsion polymerization. For example, using water as dispersing medium, 10 to 50% by weight of a monomer, based on water, 0.05 to 5% by weight of a polymerization initiator, based on monomer and 0.1 to 20% by weight of a dispersing agent, based on monomer, polymerization is carried out at a temperature of 30 to 100° C. (and preferably 60 to 90° C.) for a period of 3 to 8 hrs., while stirring. In the preparation, conditions such as amounts of a monomer and polymerization initiator, reaction temperature and reaction time can be varied. Examples of usable polymerization initiators include aqueous-dispersible peroxides (e.g., potassium persulfate, ammonium persulfate), aqueous-dispersible azo compoubnds (e.g., 2,2′-azobis(2-aminodipropane) hydrochloride) and their combination with reducing agents such as Fe²⁺ salts or sodium hydrogen sulfite, i.e., redox type polymerization initiators. Aqueous dispersible polymers are used as a dispersing agent and any one of anionic surfactants, nonionic surfactants, cationic surfactants and amphoteric surfactants is usable.

The average (i.e., number-averaged) particle size of the vinyl type polymer latex is preferably 0.005 to 2.0 μm. and more preferably 0.01 to 0.8 μm.

The foregoing vinyl type polymer latex is preferably a acryl type polymer latexes. The acryl type polymer latex is a latex of a polymer which preferably contains at least 50 mol % of an acryl monomer unit such as methacrylic acid, acrylic acid or their esters or salts, acrylamide or methacrylamide. The acryl polymer latex usable in the invention can be prepared using an acryl monomer alone or the acryl monomer and other monomers copolymerizable with the acryl monomer (hereinafter, denoted as comonomer). Examples of acryl monomers include acrylic acid; methacrylic acid, acrylic acid esters such as alkyl acrylate (e.g., methyl acrylate, ethyl acrylate, n-propyl acrylate, isopropyl acrylate, n-butyl acrylate, isobutyl acrylate, t-butyl acrylate, 2-ethylhexyl acrylate, cyclohexyl acrylate, phenyl acrylate, benzyl acrylate, phenylethyl acrylate), and hydroxy-containing alkyl acrylate (e.g., 2-hydroxyethylacrylate, 2-hydroxypropyl acrylate); methacrylic acid esters such as alkyl methacrylate (e.g., methyl methacrylate, ethyl methacrylate, n-propyl methacrylate, isopropyl methacrylate, n-butyl methacrylate, isobutyl methacrylate, t-butyl methacrylate, 2-ethylhexyl methacrylate, cyclohexyl methacrylate, phenyl methacrylate, benzyl methacrylate, phenylethyl methacrylate), and hydroxy-containing alkyl methacrylate (e.g., 2-hydroxyethyl methacrylate, 2-hydroxypropyl methacrylate); acry;amide; substituted acrylamide such as N-methylacrylamide, N-methoxymethyl acrylamide; methacrylamide; substitutedmethacrylamide such as N-methylmethacylamide, N-methylol methacylamideN,N-dimethylol methacrylamide, and n-methoxymethyl methacrylamide; amino-substituted alkyl methacrylate such as N,N-diethylaminomethacrylate; epoxy group-containing acrylate such as glycidyl acrylate; epoxy group-containing methacrylate uch as glycidyl methacrylate; and acrylate salts such as sodium salt, potassium salt and ammonium salt. The foregoing monomers may be used alone or in combination thereof.

Examples of comonomers include styrene and its derivatives; unsaturated carboxylic acid (e.g., itaconic acid, maleic acid, fumaric acid)unsaturated carboxylic acid ester (e.g., methyl itaconate, dimethyl itaconate, methyl maleate, dimethyl maleate, methyl fumarate, dimethyl fumarate); unsaturated dicarboxylate salt (e.g., sodium salt, potassium salt, ammonium salt), sulfonic acid or its salt-containing monomer (e.g., styrenesulfonic acid, vinylsulfonic acid and their salts (e.g., sodium salt, potassium salt, ammonium salt); acid anhydride such as maleic acid anhydride and itaconic acid anhydride; vinyl isocyanate; allyl isocyanate; vinyl methyl ether; vinyl ethyl ether; and vinyl acetate. The foregoing monomers can be use alone or in combination thereof.

In one preferred embodiment of the invention, the sublayer contains a aqueous-dispersible polyurethane. In the invention, the aqueous-dispersible polyurethane is commercially available aqueous-dispersible polyurethane as shown below or a solids component of an aqueous polyurethane dispersion obtained by dissolving or dispersing (1) a dihydroxy compound having a molecular weight of 750 to 3000, (2) polyisocyanate, (3) a water-solubility promoting group of a N-attached aliphatic aminocarboxylic acid or aminosulfonic acid having at least one hydrogen, and (4) compound not containing two hydrogen atoms reactive for an isocyanate as a chain extending agent and a salt group having a molecular weight of 300 or less, in an aqueous soluble organic solvent to under go reaction, and finally containing neither organic solvent nor emulsifying agent.

Examples of commercially available aqueous-dispersible polyurethane include TAKELAC XW series, W-7004, W-6015, W-621, W-511, W-310, and W-512 (available from Takeda Chemical Industries, Ltd.); impranil DLH and impranil DLN (available from Beiern Co.); Superflex 100, Superflex 200, Super flex 300, Hidran HW-140, Hidran HW-111, Hidran HW-100, Hidran Hw-101, Hidran HW-312, Hidran HW-311, Hidran HW-310, Hidran LW-513, Hidran HC-200, Hidran HC-400M, Bondic 1010C, Bondic 1050, Bondic 1070, Bondic 1310B, Bondic 1310F, Bondic 1310NS, bondic 1340, Bondic 1510, Bondic 1610NS, Bondic 1630, Bondic 1640, Bondic 1670(N), Biondic 1670-40 (available from Daiichi Kogyo Seiyakyo Co., Ltd.) Of these commercially available aqueous-dispersible polyurethanes are preferred W-70004, W-6015, Impranil DLH, Impranil DLN, Superflex 100, Superflex 200, Hidran HW-312, Hidran HW-140, Hidran HW-310, and Hidran HW-311.

In one preferred embodiment of the invention, the sublayer contains aqueous-dispersible cellulose. Aqueous dispersible cellulose usable in the invention is one having a structure in which at least one hydrogen of a hydroxy group of the cellulose is substituted with an alkyl group, hydroxyalkyl group and/or acyl group. Examples of such cellulose derivatives include hydroxymethyl cellulose, hydroxyethyl cellulose, hydroxypropyl cellulose, hydroxypropylmethyl cellulose, hydroxypropylmethyl cellulose hexahydrophthalate, methyl cellulose, ethyl cellulose, and propyl cellulose.

In one preferred embodiment of the invention, aqueous-dispersible polyesters modified by a vinyl type monomer are employed. To the aqueous-dispersible polyester modified by a vinyl type monomer may be added a vinyl type polymer latex. Further in one preferred embodiment of the invention, both an aqueous-dispersible polyester and vinyl type polymer latex are employed and an aqueous-dispersible polyester may further added thereto.

Into the sublayer relating to the invention may optionally be incorporated a filler, plasticizer, surfactant or dye. Specifically, incorporation of a filler is preferred, enhancing heat resistance in thermal processing. Fillers usable in the invention may be organic or inorganic compounds, and examples thereof include inorganic fillers such as carbon black, graphite, TiO₂, BaSO₄, ZnS, MgCO₃, CaCO₃, ZnO. CaO, WS₂, MOS₂, MgO, SnO₂Al₂O₃, α-Fe₂O₃, α-FeOOH, SiC, CeO₂, BN, SiN, MoC, BC, WC, titanium carbide, corundum, artificial diamond, garnet, silica rock, triboli, diatomite, and dolomite; and organic fillers such as polyethylene resin particles, fluororesin particles, guanamine resin particles, acryl resin particles, silicone resin particles, melamine resin particles.

The dry sublayer thickness is preferably 0.01 to 10 μm, and more preferably 0.03 to 3 μm.

A coating solution for the sublayer used in the invention may optionally contain a surfactant, swelling agent, matting agent, cross-over light-shielding dye, anti-halation dye, pigment, antifoggant, or antiseptic agent. Examples of swelling agent usable in the invention include phenol, resorcin, cresol, and chlorophenol and its amount to be incorporated is preferably 1 to 10 g per liter of a coating solution for the sublayer. A matting agent is preferably particles of silica, polystyrene or polymethyl methacrylate, having particle sizes of 0.1 to 10 μm. The sublayer can be formed by coating and drying in accordance with commonly known coating methods. Examples of coating methods include dip coating, air knife coating, curtain coating, roller coating, wire-bar coating, gravure coating, and extrusion coating described in U.S. Pat. No. 2,681,294. Two or more sublayers may be simultaneously coated in accordance with the methods described in U.S. Pat. Nos. 2,761,791, 3,508,947, 2,941,898 and 3,526,528; and Y. Harazaki “Coating Kogaku”, page 253 (published by Asakura Shoten, 1973).

The wet sublayer thickness is preferably 3 to 100 μm, and more preferably 5 to 20 μm. The wet sublayer is further dried at a temperature of 120 to 200° C. for a period of 5 sec. to 1 min. After being coated and dried, the sublayer is preferably subjected to a thermal treatment at a temperature of 120 to 200° C. for a period of 10 sec. to 10 min.

The photothermographic material may be provided with a solvent-based or water-based backing layer on the opposite side of the support from the image forming layer. The backing layer can be formed by coating a solvent-based coating solution or water-based coating solution and one or more layers may be provided. The solvent-based backing layer means a backing layer coated by using a solvent-based coating solution, and the water-based backing layer means a backing layer coated by using a water-based coating solution. The expression, solvent-based means organic solvent(s) accounting for by at least 50% of total solvents; the expression, water-based means water accounting for at least 50% of the total solvents.

Binders used in the backing layer are preferably transparent or semi-transparent, natural or synthetic polymeric compounds. Examples thereof include gelatin, Arabic gum, polyvinyl alcohol, hydroxyethyl cellulose, cellulose diacetate, cellulose acetate butyrate, polyvinyl pyrrolidine, casein, starch, polyacrylic acid, polymethyl methacrylic acid, polyvinyl chloride, polymethacrylic acid, styrene anhydrous maleic acid copolymer, styrene acrylonitrile copolymer, styrene butadiene copolymer, polyvinyl acetals (e.g., polyvinyl formal, polyvinyl butyral), polyesters, polyurethanes, phenoxy resins, polyvinylidene chloride, polyepoxides, polycarbonates, polyvinyl acetate and polyamides. Specifically, cellulose acetate butyrate as a binder for the solvent-based backing layer and polyvinyl alcohol or gelatin as a binder for the water-based backing layer are preferred.

The backing layer relating to the invention preferably exhibits a maximum absorbance of 0.3 to 2.0, and more preferably 0.5 to 2.0 within the desired wavelength region. The backing layer, after being subjected to thermal processing, preferably exhibits an optical density of 0.001 to 0.5, and more preferably 0.001 to 0.3. Further, to the backing layer may optionally be incorporated a surfactant, cross-linking agent, or lubricant. There may be provided a backing resistive heating layer, described in U.S. Pat. No. 4,460,681. The thickness of the backing layer is preferably 0.1 to 20 μm, and more preferably 0.5 to 10 μm.

There may be provided a protective layer (backing layer side-protective layer) on the backing layer of the photothermographic material relating to the invention. Binders usable in the backing side-protective layer are not specifically limited and the same polymers as used in the backing layer are usable. The backing side-protective layer is preferably formed by coating a water-based coating solution and drying it. There may optionally be incorporated a mating agent, dye, lubricant or surfactant into the backing side-protective layer. The thicknes of the backing side-protective laye is preferably 0.1 to 10 μm, and more preferably 0.5 to 5 μm.

The polyester of the polyester support relating to the invention refers to a polymer obtained by polycondensation of a diol and a dicaboxylic acid. Representative examples of dicarboxylic acids include terephthalic acid, isophthalic acid, phthalic acid, naphthalene-dicarboxylic acid, adipinic acid, and sebacic acid; and representative examples of diols include ethylene glycol, trimethylene glycol, tetramethylene glycol, and cyclohexane dimethanol. Exemplary examples of polyesters include polyethyelene terephthalate, polyethylene-p-oxybenzoatepoly-1,4-cyclohexylene-dimethylene terephthalate, and polyethylene-2,4-naphthalanedicarboxylate. Of these, polyethylene terephthalate and polyethylene naphthalate are preferable in the invention. Specifically, polyethylene terephthalate film is superior in water resistance, fastness properties and resistance to chemicals. These polyesters may be homo-polyester or co-polyester. As a copolymerizing component are cited a diol component such as diethylene glycol, neopentyl glycol or polyalkylene glycol, and a dicarboxylic acid componebt such as adipinic acid, sebacic acid, phthalic acid, 2,6-naphthalene-dicarboxylic acid or 5-sodium-sulfoisophthalic acid.

Fine particles of calcium carbonate, non-crystalline zeolite, anatase type titanium dioxide, calcium phosphate, silica, kaolin, talc or clay may be incorporated into the polyester support relating to the invention. The amount thereof is preferably 0.0005 to 15 parts per 100 parts of polyester composition. Fine particles precipitated from reaction of the catalyst residue in polyester-condensation and a phosphorus compound may be used in combination with the foregoing fine particles. Examples of such precipitated fine particles include one comprised of calcium, lithium and phosphorus compounds and one comprised of calcium, magnesium and phosphorus compounds. The content of such fine particles is preferably 0.05 to 1.0 part per 100 parts by weight of polyester. In addition thereto, the polyester support may be added with commonly known additives such as antioxidant or dye.

The thickness of a polyester support is preferably 10 to 250 μm, and more preferably 15 to 200 μm. To minimize roll-set curl, the polyester support may be subjected to a thermal treatment at a temperature lower than the glass transition point of the support for a period of 0.1 to 1500 hrs, as described in JP-A 51-16358 (hereinafter, the term, JP-A means an unexamined, published Japanese Patent Application). To enhance adhesion property, the polyester support may be subjected to a commonly known surface treatment or chemical treatment (described in JP-B 34-11031, 38-22148, 40-2276, 41-16423 and 44-5116; hereinafter, the term, JP-B means a published Japanese Patent), chemical or mechanical surface-roughening treatment (described in JP-B 47-19068, and 55-5104), a corona discharge treatment (described in JP-B 39-12838, JP-A 47-19824, 48-28067), flame treatment (described in JP-B 40-12384 and JP-A 48-85126), ultraviolet ray treatment (described in JP-A 36-18915, 37-14493, 43-2603, 43-2604, 52-25726), a high-frequency treatment (described in JP-B 49-10687), a glow discharge treatment (described in JP-B 37-17682), an active plasma treatment or a laser treatment. The contact angle between the support and water is preferably not more than 580. The polyester support may be transparent or opaque, or tinted.

Next, thermally developable photothermographic materials will be described. Thermally developable silver halide photothermographic materials are disclosed in D. Morgan and B. Shely, U.S. Pat. Nos. 3,152,904 and 3,457,075; D. Morgan “Dry Silver Photographic material”; and D. H. Klosterboer, “Thermally Processed Silver Systems” in Imaging Processes and Materials, Neblette's Eighth Edition, Edited by J. M. Sturge, V. Walworth and A. Shepp, page 2, 1989.

The photothermographic material relating to the invention is characterized in that the photothermographic material forms images upon heating at a temperature of 80 to 150° C., without being subjected to fixing. Although silver halide and organic silver salt in unexposed areas remain in the photothermographic image forming layer without being removed, no increase in fog density occurs unless heated. Thermally processed photothermographic material preferably exhibits an optical density at the wavelength at 400 nm of not more than 0.2, and more preferably 0.02 to 0.2.

Silver halide grains contained in the photothermographic image forming layer function as a light sensor. In order to minimize cloudiness after image formation and to obtain excellent image quality, the less the average grain size, the more preferred, and the average grain size is preferably less than 0.1 μm, more preferably between 0.01 and 0.1 μm, and still more preferably between 0.02 and 0.08 μm. The average grain size as described herein is defined as an average edge length of silver halide grains, in cases where they are so-called regular crystals in the form of cube or octahedron. Furthermore, in cases where grains are not regular crystals, for example, spherical, cylindrical, and tabular grains, the grain size refers to the diameter of a sphere having the same volume as the silver grain. Furthermore, silver halide grains are preferably monodisperse grains. The monodisperse grains as described herein refer to grains having a monodispersibility obtained by the formula described below of less than 30%, and more preferably from 0.1 to 20%.

Monodispersibility=(standard deviation of grain diameter)/(average grain diameter)×100(%)

The silver halide grain shape is not specifically limited, but a high ratio accounted for by a Miller index [100] plane is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized. Furthermore, another preferred silver halide shape is a tabular grain. The tabular grain as described herein is a grain having an aspect ratio (AR), as defined below, of at least 3:

AR =grain diameter (μm)/grain thickness (μm) Of these, the aspect ratio is preferably between 3 and 50. The grain diameter is preferably not more than 0.1 μm, and is more preferably between 0.01 and 0.08 μm. These are described in U.S. Pat. No. 5,264,337, 5,314,789, 5,320,958, and others. In the present invention, when these tabular grains are used, image sharpness is further improved. The composition of silver halide may be any of silver chloride, silver chlorobromide, silver iodochlorobromide, silver bromide, silver iodobromide, or silver iodide.

The halide composition of silver halide grains is not specifically limited and may be any one of silver chloride, silver chlorobromide, silver iodochlorobromide, silver bromide, silver iodobromide and silver iodide. Silver halide emulsions used in the invention can be prepared according to the methods described in P. Glafkides, Chimie Physique Photographique (published by Paul Montel Corp., 19679; G.F. Duffin, Photographic Emulsion Chemistry (published by Focal Press, 1966); V. L. Zelikman et al., Making and Coating of Photographic Emulsion (published by Focal Press, 1964). Any one of acidic precipitation, neutral precipitation and ammoniacal precipitation is applicable and the reaction mode of aqueous soluble silver salt and halide salt includes single jet addition, double jet addition and a combination thereof. Silver halide may be incorporated into the image forming layer by any means so that the silver halide is arranged so as to be close to reducible silver source. The silver halide may be formed by reaction of an organic silver salt and a halide ion to convert a part of the organic silver salt to silver halide. Alternatively, silver halide which has been prepared in advance may be added to a solution to prepare.an organic silver salt. A combination of these may be applicable bur the latter is preferred. The content of silver halide is preferably 0.75 to 30% by weight, based on an organic silver salt.

Silver halide preferably occludes ions of metals belonging to Groups 6 to 11 of the Periodic Table. Preferred as the metals are W; Fe, Co, Ni, Cu, Ru, Rh, Pd, Re, Os, Ir, Pt and Au.

These metals may be introduced into silver halide in the form of a complex. In the present invention, regarding the transition metal complexes, six-coordinate complexes represented by the general formula described below are preferred:

Formula:

(ML₆)^{m}:

wherein M represents a transition metal selected from elements in Groups 6 to 11 of the Periodic Table; L represents a coordinating ligand; and m represents 0, 1-, 2-, 3- or 4-. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When the aquo ligand is present, one or two ligands are preferably coordinated. L may be the same or different.

The particularly preferred example of M is rhodium (Rh), ruthenium (Ru), rhenium (Re), iridium (Ir) or osmium (Os).

Exemplary examples of transition metal ligand complexes are shown below.

1: [RhCl₆]³⁻

2: [RuCl₆]³⁻

3: [ReCl₆]³⁻

4: [RuBr₆]³⁻

5: [OsCl₆]³⁻

6: [IrCl₆]⁴⁻

7: [Ru(NO) Cl₅]²⁻

8: [RuBr₄(H₂O )]²⁻

9: [Ru(NO)(H₂O ) Cl₄]⁻

10: [RhCl₅(H₂O )]²⁻

11: [Re(NO)Cl₅]²⁻

12: [Re(NO)CN₅]²⁻

13: [Re(NO)Cl(CN)₄]²⁻

14: [Rh (NO)₂Cl₄]⁻

15: [Rh(NO)(H₂O)Cl₄]⁻

16: [Ru(NO)CN₅]²⁻

17: [Fe(CN)₆]³⁻

18: [Rh(NS)Cl₅] ²⁻

19: [Os(NO)Cl₅]²⁻

20: [Cr(NO)Cl₅]²⁻

21: [Re(NO)Cl₅]⁻

22: [Os(NS)Cl₄(TeCN)]²⁻

23: [Ru(NS)Cl₅]²⁻

24: [Re(NS)Cl₄(SeCN)]²⁻

25: [Os(NS)Cl(SCN)₄]²⁻

26: [Ir(NO)Cl₅]²⁻

27: [Ir(NS)Cl₅]²⁻

One type of these metal ions or complex ions may be employed and the same type of metals or the different type of metals may be employed in combinations of two or more types. Generally, the content of these metal ions or complex ions is suitably between 1×10⁻⁹ and 1×10⁻² mole per mole of silver halide, and is preferably between 1×10⁻⁸ and 1×10⁻⁴ mole.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, these are preferably added at the stage of nuclei formation, growth, and physical ripening; furthermore, are preferably added at the stage of nuclei formation and growth; and are most preferably added at the stage of nuclei formation.

These compounds may be added several times by dividing the added amount. Uniform content in the interior of a silver halide grain can be carried out. As disclosed in JP-A No. 63-29603, 2-306236, 3-167545, 4-76534, 6-110146, 5-273683, the metal can be distributedly occluded in the interior of the grain.

These metal compounds can be dissolved in water or a suitable organic solvent (for example, alcohols, ethers, glycols, ketones, esters, amides, etc.) and then added. Furthermore, there are methods in which, for example, an aqueous metal compound powder solution or an aqueous solution in which a metal compound is dissolved along with NaCl and KCl is added to a aqueous-dispersible silver salt solution during grain formation or to a aqueous-dispersible halide solution; when a silver salt solution and a halide solution are simultaneously added, a metal compound is added as a third solution to form silver halide grains, while simultaneously mixing three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous metal compound powder solution or an aqueous solution in which a metal compound is dissolved along with NaCl and KCl is added to a aqueous-dispersible halide solution. When the addition is carried out onto grain surfaces, an aqueous solution comprising the necessary amount of a metal compound can be placed in a reaction vessel immediately after grain formation, or during physical ripening or at the completion thereof or during chemical ripening.

In general, formed silver halide grains are subjected to desalting to remove soluble salts by a noodle washing method or flocculation method; however, silver halide grains used in the invention may be or may be not subjected to desalting.

Silver halide grains used in the photothermographic materials relating to the invention are preferably be subjected to chemical sensitization. As is commonly known in the art, the chemical sensitization includes, for example, sulfur sensitization, selenium sensitization, tellurium sensitization. There are also applicable in the invention noble metal sensitization with gold compounds or platinum, palladium or iridium compounds, or reduction sensitization. Compounds commonly known in sulfur sensitization, selenium sensitization or tellurium sensitization are suitably used, as described in JP-A 7-128768. Examples of tellurium sensitizers include diacyltellurides, bis(oxycarbonyl)tellurides, bis(carbamoyl)tellurides, diacyltellurides, bis(oxycarbonylditellurides, bis(carbamoyl)ditellurides, compounds containing a P═Te bond, tellurocarboxylic acid salts, Te-organyltellurocarboxylic acid esters, di(poly)tellurides, tellurides, tellurols, telluroacetals, tellurosufonates, compounds containing a P—Te bond, Te-containing heterocyclic compounds, tellurocarbonyl compounds, inorganic tellurium compounds and colloidal tellurium. Preferred compounds used in noble metal sensitization include, for example, chloroauric acid, potassium chloroaurate, potassium aurothiocyanate, gold sulfide, gold selenide, and compounds described in U.S. Pat. No. 2,448,060 and British Patent 618,061. Examples of compound used in reduction sensitization include stannous chloride, aminoiminomethanesulfinic acid, hydrazine derivatives, borane compounds, silane compounds and polyamines. Reduction sensitization can be conducted by ripening an emulsion with maintaining the emulsion at a pH of not less than 7 or a pAg of not more than 8.3. Further, single addition of silver ions may be introduced during grain formation to undergo reduction sensitization.

Organic silver salts used in the invention are reducible silver source, and silver salts of organic acids or organic heteroacids are preferred and silver salts of long chain fatty acid (preferably having 10 to 30 carbon atom and more preferably 15 to 25 carbon atoms) or nitrogen containing heterocyclic compounds are more preferred. Specifically, organic or inorganic complexes, ligands of which have a total stability constant to a silver ion of 4.0 to 10.0 are preferred. Exemplary preferred complex salts are described in RD17029 and RD29963, including organic acid salts (for example, salts of gallic acid, oxalic acid, behenic acid, stearic acid, palmitic acid, lauric acid, etc.); carboxyalkylthiourea salts (for example, 1-(3-carboxypropyl)thiourea, 1-(3-caroxypropyl)-3,3-dimethylthiourea, etc.); silver complexes of polymer reaction products of aldehyde with hydroxy-substituted aromatic carboxylic acid (for example, aldehydes (formaldehyde, acetaldehyde, butylaldehyde, etc.), hydroxy-substituted acids (for example, salicylic acid, benzoic acid, 3,5-dihydroxybenzoic acid, 5,5-thiodisalicylic acid, silver salts or complexes of thiones (for example, 3-(2-carboxyethyl)-4-hydroxymethyl-4-(thiazoline-2-thione and 3-carboxymethyl-4-thiazoline-2-thione), complexes of silver with nitrogen acid selected from imidazole, pyrazole, urazole, 1.2,4-thiazole, and lH-tetrazole, 3-amino-5-benzylthio-1,2,4-triazole and benztriazole or salts thereof; silver salts of saccharin, 5-chlorosalicylaldoxime, etc.; and silver salts of mercaptides. Of these organic silver salts, silver salts of fatty acids are preferred, and silver salts of behenic acid, arachidic acid and stearic acid are specifically preferred.

The organic silver salt compound can be obtained by mixing an aqueous-soluble silver compound with a compound capable of forming a complex. Normal precipitation, reverse precipitation, double jet precipitation and controlled double jet precipitation described in JP-A 9-127643 are preferably employed. For example, to an organic acid is added an alkali metal hydroxide (e.g., sodium hydroxide, potassium hydroxide, etc.) to form an alkali metal salt soap of the organic acid (e.g., sodium behenate, sodium arachidate, etc.), thereafter, the soap and silver nitrate are mixed by the controlled double jet method to form organic silver salt crystals. In this case, silver halide grains may be concurrently present.

In the present invention, organic silver salts have an average grain diameter of 1 μm or less and are monodisperse. The average diameter of the organic silver salt as described herein is, when the grain of the organic salt is, for example, a spherical, cylindrical, or tabular grain, a diameter of the sphere having the same volume as each of these grains. The average grain diameter is preferably between 0.01 and 0.8 μm, and more preferably between 0.05 and 0.5 μm. Furthermore, the monodisperse as described herein is the same as silver halide grains and preferred monodispersibility is between 1 and 30%. It is also preferred that at least 60% of the total of the organic silver salt is accounted for by tabular grains. The tabular grains refer to grains having a ratio of an average grain diameter to grain thickness, i.e., aspect ratio of 3 or more. To obtain such tabular organic silver salts, organic silver salt crystals are pulverized together with a binder or surfactant, using a ball mill. Thus, using these tabular grains, light sensitive materials exhibiting high density and superior image fastness are obtained.

To prevent hazing of the photothermographic material, the total amount of silver halide and organic silver salt is preferably 0.5 to 2.2 g in equivalent converted to silver per m², thereby leading to high contrast images. The amount of silver halide is preferably not more than 50%, more preferably not more than 25%, and still more preferably 0.1 to 15% by weight, based on total silver content.

Reducing agents are preferably incorporated into the thermally developable photothermographic material of the present invention. Examples of suitable reducing agents are described in U.S. Pat. Nos. 3,770,448, 3,773,512, and 3,593,863, and Research Disclosure Items 17029 and 29963, and include the following: aminohydroxycycloalkenone compounds (for example, 2-hydroxypiperidino-2-cyclohexane); esters of amino reductones as the precursor of reducing agents (for example, piperidinohexose reducton monoacetate); N-hydroxyurea derivatives (for example, N-p-methylphenyl-N-hydroxyurea); hydrazones of aldehydes or ketones (for example, anthracenealdehyde phenylhydrazone; phosphamidophenols; phosphamidoanilines; polyhydroxybenzenes (for example, hydroquinone, t-butylhydroquinone, isopropylhydroquinone, and (2,5-dihydroxy-phenyl)methylsulfone); sulfydroxamic acids (for example, benzenesulfhydroxamic acid); sulfonamidoanilines (for example, 4-(N-methanesulfonamide)aniline); 2-tetrazolylthiohydroquinones (for example, 2-methyl-5-(1-phenyl-5-tetrazolylthio)hydroquinone); tetrahydroquinoxalines (for example, 1,2,3,4-tetrahydroquinoxaline); amidoxines; azines (for example, combinations of aliphatic carboxylic acid arylhydrazides with ascorbic acid); combinations of polyhydroxybenzenes and hydroxylamines, reductones and/or hydrazine; hydroxamic acids; combinations of azines with sulfonamidophenols; α-cyanophenylacetic acid derivatives; combinations of bis-β-naphthol with 1,3-dihydroxybenzene derivatives; 5-pyrazolones, sulfonamidophenol reducing agents, 2-phenylindane-1,3-dione, etc.; chroman; 1,4-dihydropyridines (for example, 2,6-dimethoxy-3,5-dicarboethoxy-1,4-dihydropyridine); bisphenols (for example, bis(2-hydroxy-3-t-butyl-5-methylphenyl)methane, bis(6-hydroxy-m-tri)mesitol, 2,2-bis(4-hydroxy-3-methylphenyl)propane, 4,5-ethylidene-bis(2-t-butyl-6-methyl)phenol, UV-sensitive ascorbic acid derivatives and 3-pyrazolidones. Of these, particularly preferred reducing agents are hindered phenols.

As hindered phenols listed are compounds represented by the general formula (A) described below:

Formula (A)

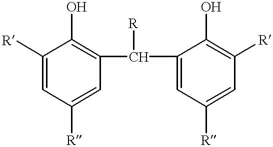

wherein R represents a hydrogen atom or an alkyl group having from 1 to 10 carbon atoms (for example, —C₄H₉, 2,4,4-trimethylpentyl), and R′ and R″ each represents an alkyl group having from 1 to 5 carbon atoms (for example, methyl, ethyl, t-butyl).

Exemplary examples of the compounds represented by the formula (A) are shown below:

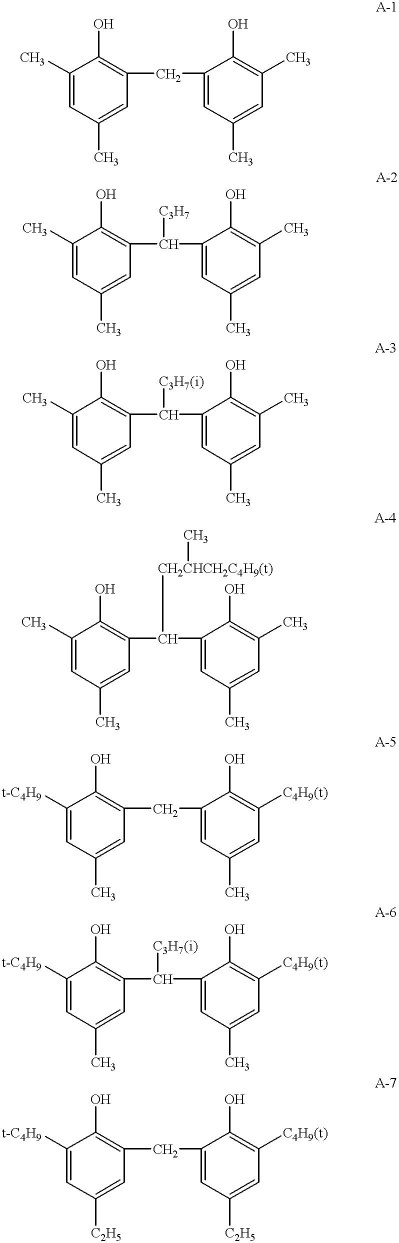

The used amount of reducing agents represented by the above-mentioned general formula (A) is preferably between 1×10⁻² and 10 moles, and is more preferably between 1×10⁻² and 1.5 moles per mole of silver.

Binders suitable for image formation in the photothermographic materials relating to the invention may be transparent or translucent, including colorless natural or synthetic polymeric compounds. Thus, binders are natural polymers, synthetic resins, and polymers and copolymers, other film forming media, including, for example, gelatin, gum arabic, poly(vinyl alcohol), hydroxyethyl cellulose, cellulose acetate, cellulose acetatebutylate, poly(vinyl pyrrolidone), casein, starch, poly(acrylic acid), poly(methyl methacrylic acid), poly(vinyl chloride), poly(methacrylic acid), co(styrene-maleic acid anhydride)polymer, co(styrene-acrylonitrile)polymer, co(styrene-butadiene)polymer, poly(vinyl acetal) series (for example, poly(vinyl formal)and poly(vinyl butyral), polyester series, poly(urethane) series, phenoxy resins, poly(vinylidene chloride), polyepoxide series, polycarbonate series, poly(vinyl acetate) series, cellulose esters, polyamide series. A light-insensitive layer may be provided on the outer side of the photothermographic image forming layer to protect the surface of photothermographic materials or prevent the surface from abrasion marks. Binder used in the light-insensitive layer may be the same or different from that used in the light sensitive layer. These may be hydrophilic or hydrophobic. In the present invention, the amount of the binder in a light sensitive layer is preferably between 1.5 and 6 g/m², and is more preferably between 1.7 and 5 g/m². Suitable contents of image forming materials can maintain the image density.

In the present invention, a matting agent is preferably incorporated into the image forming layer side. In order to minimize the image abrasion after thermal development, the matting agent is provided on the surface of the photothermographic image forming layer and the matting agent is preferably incorporated in an amount of 0.5 to 30 percent in weight ratio with respect to the total binder in the emulsion layer side. Materials of the matting agents employed in the present invention may be either organic substances or inorganic substances. Regarding inorganic substances, for example, those can be employed as matting agents, which are silica described in Swiss Patent No. 330,158, etc.; glass powder described in French Patent No. 1,296,995, etc.; and carbonates of alkali earth metals or cadmium, zinc, etc. described in U.K. Patent No. 1.173,181, etc. Regarding organic substances, as organic matting agents those can be employed which are starch described in U.S. Pat. No. 2,322,037, etc.; starch derivatives described in Belgian Patent No. 625,451, U.K. Patent No. 981,198, etc.; polyvinyl alcohols described in Japanese Patent Publication No. 44-3643, etc.; polystyrenes or polymethacrylates described in Swiss Patent No. 330,158, etc.; polyacrylonitriles described in U.S. Pat. No. 3,079,257, etc.; and polycarbonates described in U.S. Pat. No. 3,022,169. The shape of the matting agent may be crystalline or amorphous. However, a crystalline and spherical shape is preferably employed. The size of a matting agent is expressed in the diameter of a sphere which has the same volume as the matting agent. The particle diameter of the matting agent in the present invention is referred to the diameter of a spherical converted volume. The matting agent employed in the present invention preferably has an average particle diameter of 0.5 to 10 μm, and more preferably of 1.0 to 8.0 μm.

The silver halide photothermographic material used in the invention is subjected to thermal development to form photographic images, preferably comprising reducible silver source (organic silver salts), silver halide in an amount necessary to exhibit catalytic activity, a hydrazine derivative and a reducing agent, and, optionally, a toning agent restraining silver image tone, which are dispersed in (organic) binder matrix. The silver halide photothermographic materials are stable at ordinary temperatures, and are developed on heating, after exposure, at a high temperature (e.g., 80 to 140° C.), forming silver on heating through oxidation-reduction reaction between an organic silver salt (which functions as an oxidizing agent) and a reducing agent. The oxidation-reduction reaction is catalytically accelerated by silver formed upon exposure to light. Silver produced from the reaction of the organic silver salt in an exposed area gives a black image distinguishable from an unexposed area to perform image formation. This reaction process can proceed without supplying a processing solution such as water from the outside.

The silver halide photothermographic materials relating to the invention have at least an image forming layer on the support. There may be provided the image forming layer alone, but further thereon, at least a light-insensitive layer is preferably provided. To control the amount or wavelength distribution of light transmitting through the image forming layer, a filter layer may be provided on the same side or opposite side to the image forming layer. Further, the image forming layer may contain a dye or pigment. There are usable compounds described in JP-A 59-6481 and 59-182436; U.S. Pat. No. 4,271,263, and 4,594,312; European Patent 533,008 and 652,473; and JP-A 2-216140, 4-348339, 7-191432 and 7-301890.

Further, the light-insensitive layer is preferably added with the binder or matting agent described above, and may be added with a lubricant such as polysiloxane compounds, wax, or liquid paraffin. The photothermographic image forming layer may be comprised of plural layers, or high-speed and low-speed layers to adjust gradation.

Image toning agents are preferably incorporated into the photothermographic material used in the present invention. Examples of preferred image toning agents are disclosed in Research Disclosure Item 17029, and include the following:

imides (for example, phthalimide), cyclic imides, pyrazoline-5-one, and quinazolinone (for example, succinimide, 3-phenyl-2-pyrazoline-5-on, 1-phenylurazole, quinazoline and 2,4-thiazolidione); naphthalimides (for example, N-hydroxy-1,8-naphthalimide); cobalt complexes (for example, cobalt hexaminetrifluoroacetate), mercaptans (for example, 3-mercapto-1,2,4-triazole); N-(aminomethyl)aryldicarboxyimides (for example, N-(dimethylaminomethyl)phthalimide); blocked pyrazoles, isothiuronium derivatives and combinations of certain types of light-bleaching agents (for example, combination of N,N′-hexamethylene(1-carbamoyl-3,5-dimethylpyrazole), 1,8-(3,6-dioxaoctane)bis-(isothiuroniumtrifluoroacetate), and 2-(tribromomethyl-sulfonyl)benzothiazole; merocyanine dyes (for example, 3-ethyl-5-((3-etyl-2-benzothiazolinylidene-(benzothiazolinylidene))-1-methylethylidene-2-thio-2,4-oxazolidinedione); phthalazinone, phthalazinone derivatives or metal salts thereof (for example, 4-(1-naphthyl)phthalazinone, 6-chlorophthalazinone, 5,7-dimethylphthalazinone, and 2,3-dihydro-1,4-phthalazinedione); combinations of phthalazinone and sulfinic acid derivatives (for example, 6-chlorophthalazinone and benzenesulfinic acid sodium, or 8-methylphthalazinone and p-trisulfonic acid sodium); combinations of phthalazine and phthalic acid; combinations of phthalazine (including phthalazine addition products) with at least one compound selected from maleic acid anhydride, and phthalic acid, 2,3-naphthalenedicarboxylic acid or o-phenylenic acid derivatives and anhydrides thereof (for example, phthalic acid, 4-methylphthalic acid, 4-nitrophthalic acid, and tetrachlorophthalic acid anhydride); quinazolinediones, benzoxazine, naphthoxazine derivatives, benzoxazine-2,4-diones (for example, 1,3-benzoxazine-2,4-dione); pyrimidines and asymmetry-triazines (for example, 2,4-dihydroxypyrimidine), and tetraazapentalene derivatives (for example, 3,6-dimercapto-1,4-diphenyl-1H,4H-2,3a,5,6a-tatraazapentalene). Preferred image color control agents include phthalazone or phthalazine.

To the photothermographic image forming layer, mercapto compounds, disulfide compounds and thione compounds may be incorporated to retard or promote thermal development, enhance spectral sensitization efficiency or improve image lasting quality. Specifically, meracapto compounds represented by general formulas Ar-SM1 and Ar—S—S—Ar, in which M1 is a hydrogen atom or an alkali metal atom; and Ar is an aromatic ring or a condensed aromatic ring containing at least one of nitrogen, sulfur, oxygen, selenium and tellurium. Such preferred heterocyclic rings include benzimidazole, naphthoimidazole, benzothiazole, naphthothiazole, benzoxazole, naphthooxazole, benzoselenazole, benzotellurazole, imidazole, oxazole, pyrazole, triazole, thiadiazole, tetrazole, triazines, pyrimidine, pyridazine, pyrazine, pyridine, purine quinoline and quinazoline. The heterocyclic rings may contain a substituent selected from a halogen atom (e.g., Br, Cl), hydroxy, amino group, carboxyl group, alkyl (for example, having 1 to 4 carbon atoms) and alkoxy (for example, having 1 to 4 carbon atoms). Examples of such mercapto-substituted heterocyclic compounds include 2-mercaptobenzimidazole, 2-mercaptobenzoxazole, 2-mercaptobenzthiazole, 2-mercapto-5-methylbenzthiazole, 3-mercapto-1,2,4-triazole, 2-mercaptoquinoline, 8-mercaptopurine, 2,3,5,6-tetrachloro-4-pyridinethiol, 4-hydroxy-2-mercaptopyrimidine, and 2-mercapto-4-phenyloxazole. The compounds usable in the invention are not limited to these compounds.

Antifoggants may be incorporated into the photothermographic material to which the present invention is applied, as disclosed in U.S. Pat. Nos. 4,546,075 and 4,452,885, and Japanese Patent Publication Open to Public Inspection No. 59-57234. Particularly preferred mercury-free antifoggants are heterocyclic compounds having at least one substituent, represented by —C(X1)(X2)(X3) (wherein X1 and X2 each represent halogen, and X3 represents hydrogen or halogen), as disclosed in U.S. Pat. Nos. 3,874,946 and 4,756,999. As examples of suitable antifoggants, employed preferably are compounds described in paragraph numbers [0062] and [0063] of JP-A No. 9-90550. Furthermore, other suitable antifoggants are disclosed in U.S. Pat. No. 5,028,523, and British Patent Application Nos. 92221383.4, 9300147.7, and 9311790.1.

In silver halide photothermographic materials relating to the invention are used sensitizing dyes described in JP-A 63-159841, 60-140335, 63-231437, 63-259651, 63-304242, and 63-15245; U.S. Pat. Nos. 4,639,414, 4,740,455, 4,741,966, 4,751,175 and 4,835,096. Sensitizing dyes usable in the invention are described in Research Disclosure Item 17643, Sect. IV-A (December, 1978 page 23), ibid, Item 1831 Sect. X (August, 1978, page 437) and cited literatures. There can be advantageously sensitizing dyes having spectral sensitivity suited for spectral characteristics of various scanner light sources. Compounds described in JP-A 9-34078, 9-54409 and 9-80679 are specifically preferred.

Latent images produced in exposure are developed by heating the photothermographic material at a relatively high temperature (e.g., 8- to 200° C., and preferably 100 to 200° C.) for a sufficient period of time (generally ca. 1 sec to ca. 2 min.) At a heating temperature lower than 80° C., images having sufficiently high densities cannot be obtained for a short period of time and at a temperature higher than 200° C., the binder melts and is transferred to rollers, adversely affecting not only images but also tracking characteristics and a processor. Heating causes oxidation-reduction reaction between the organic silver salt (functioning as an oxidant) and the reducing agent to form silver images.

In exposure of a photothermographic material, it is desirable to use a light source meeting spectral sensitivity of the photothermographic material. In the case of an infrared-sensitive photothermographic material, any light source within the infrared region is applicable and infrared semiconductor lasers (780 nm, 820 nm) are preferred in terms of being high power and making the photothermographic material transparent.

In the invention, exposure is preferably conducted by laser scanning exposure and various methods are applicable to its exposure. One of the preferred embodiments is the use of a laser scanning exposure apparatus, in which scanning laser light is not exposed at an angle substantially vertical to the exposed surface of the photothermographic material. The expression “laser light is not exposed at an angle substantially vertical to the exposed surface” means that laser light is exposed preferably at an angle of 55 to 880, more preferably 60 to 86°, still more preferably 65 to 84°, and optimally 70 to 82°.

In the second preferred embodiment of the invention, exposure applicable in the invention is conducted preferably using a laser scanning exposure apparatus producing longitudinally multiple scanning laser light, whereby deterioration in image quality such as occurrence of interference fringe-like unevenness is reduced, as compared to scanning laser light with longitudinally single mode.

In the third preferred embodiment of the invention, it is preferred to form images by scanning exposure using at least two laser beams. The image recording method using such plural laser beams is a technique used in image-writing means of a laser printer or a digital copying machine for writing images with plural lines in a single scanning to meet requirements for higher definition and higher speed, as described in JP-A 60-166916. This is a method in which laser light emitted from a light source unit is deflection-scanned with a polygon mirror and an image is formed on the photoreceptor through an fθ lens, and a laser scanning optical apparatus similar in principle to an laser imager.

In the first, second and third preferred embodiments of the image recording method of the invention, lasers for scanning exposure used in the invention include, for example, solid-state lasers such as ruby laser, YAG laser, and glass laser; gas lasers such as He—Ne laser, Ar laser, Kr ion laser, CO₂ laser, Co laser, He—Cd laser, N₂ laser and eximer laser; semiconductor lasers such as InGa laser, AlGaAs laser, GaAsP laser, InGaAs laser, InAsP laser, CdSnP₂ laser, and GSb laser; chemical lasers; and dye lasers. Of these, semiconductor lasers of wavelengths of 600 to 1200 nm are preferred in terms of maintenance and the size of the light source. When exposed onto the photothermographic imaging material in the laser imager or laser image-setter, the beam spot diameter on the exposed surface is 5 to 75 μm as a minor axis diameter and 5 to 100 μm as a major axis diameter. The laser scanning speed is set optimally for each photothermographic material, according to its sensitivity at the laser oscillation wavelength and the laser power.

### EXAMPLES

Embodiments of the present invention is further described based on examples but by no means limited to these.

### Example 1

Preparation of Aqueous dispersible Polymer Solution

An aqueous solution of each aqueous-dispersible polymer (18% by weight solids) was prepared in accordance with the following procedure.

Preparation of Aqueous-dispersible Polyester Solution A-1

Dimethyl terephthalate of 35.4 parts by weight, 33.63 parts by weight of dimethyl isophthalate, 17.92 parts by weight of dimethyl 5-sufoisophthalate sodium salt, 62 parts by weight of ethylene glycol, 0.065 parts by weight of calcium acetate monohydrate and 0.022 parts by weight of manganese acetate were allowed to undergo transesterification at a temperature of 170 to 220° C. under nitrogen gas stream, while methanol being distilled away, then, adding 0.04 parts by weight of trimethyl phosphate, 0.04 parts by weight of antimony trioxide, as polycondensation catalyst and 6.8 parts by weight of 4-cyclohexanedicarboxylic acid, esterification was performed at a reaction temperature of 220 to 235° C., while the theoretical amount of water was substantially distilled away. Thereafter, the pressure of the reaction system was reduced in 1 hr. and the temperature was raised and polycondensation was performed at 280° C. and 133 Pa for 1 hr to obtain aqueous-dispersible polyester A-1. The obtained aqueous-dispersible polyester A-1 exhibited an intrinsic viscosity of 0.33. Subsequently, to a 2 liter three-necked flask provided with a stirring blade, a reflux condenser and a thermometer was added 850 ml of pure water and 150 g of aqueous-dispersible polyester A-1 was gradually added, while rotating the stirring blade. After stirring at room temperature for 30 min., the internal temperature was raised 98° C. in 1.5 hr. and heating dissolution was continued at this temperature for 3 hrs. After completion of heating, the reaction mixture was cooled to room temperature in 1 hr. and was allowed to stand for one night to obtain a 15% by weight aqueous-dispersible polyester A-1 solution.

Preparation of Aqueous-dispersible Polyester Solution A-2

Dimethyl terephthalate of 34.02 parts by weight, 25.52 parts by weight of dimethyl isophthalate, 12.97 parts by weight of dimethyl 5-sufoisophthalate sodium salt, 47.85 parts by weight of ethylene glycol, 18.95 parts by weight of 1,4-cyclohexadimethanol, 0.065 parts by weight of calcium acetate monohydrate and 0.022 parts by weight of manganese acetate were allowed to undergo transesterification at a temperature of 170 to 220° C. under nitrogen gas stream, while methanol being distilled away, then, adding 0.04 parts by weight of trimethyl phosphate, 0.04 parts by weight of antimony trioxide, as polycondensation catalyst and 15.08 parts by weight of 4-cyclohexanedicarboxylic acid, esterification was performed at a reaction temperature of 220 to 235° C., while the theoretical amount of water was substantially distilled away. Thereafter, the pressure of the reaction system was reduced in 1 hr. and the temperature was raised and polycondensation was performed at 280° C. and 1 mm Hg or less for 1 hr to obtain aqueous-dispersible polyester A-1. The obtained aqueous-dispersible polyester A-2 exhibited an intrinsic viscosity of 0.35. Subsequently, to a 2 liter three-necked flask provided with a stirring blade, a reflux condenser and a thermometer was added 850 ml of pure water and 150 g of aqueous-dispersible polyester A-2 was gradually added, while rotating the stirring blade. After stirring at room temperature for 30 min., the internal temperature was raised 98° C. in 1.5 hr. and heating dissolution was continued at this temperature for 3 hrs. After completion of heating, the reaction mixture was cooled to room temperature in 1 hr. and was allowed to stand for one night to obtain a 15% by weight aqueous-dispersible polyester A-2 solution.

Preparation of Modified Aqueous-dispersible Polyester Solution B-1

To a 3 liter three-necked flask provided with a stirring blade, a reflux condenser, a thermometer and a dropping funnel was added 1900 ml of a 15% by weight aqueous-dispersible polyester A-2 solution and the internal temperature was raised to 80° C. Further thereto was added 6.52 ml of an aqueous 24% ammonium peroxide solution and a monomer mixture solution (containing 7.0 g of glycidyl methacrylate, 26.4 g of ethyl acrylate and 37.9 g of methyl methacrylate) was dropped in 30 min. and the reaction was further continued for 3 hrs. Then, the reaction mixture was cooled to 30° C. and filtered to obtain a modified aqueous-dispersible polyester solution B-1 (18% by weight solids).

Preparation of Modified Aqueous-dispersible Polyester Solution B-2

To a 3 liter three-necked flask provided with a stirring blade, a reflux condenser, a thermometer and a dropping funnel was added 1900 ml of a 15% by weight aqueous-dispersible polyester A-1 solution and the internal temperature was raised to 80° C. Further thereto was added 6.52 ml of an aqueous 24% ammonium peroxide solution and a monomer mixture solution (containing 28.5 g of glycidyl methacrylate, 21.4 g of ethyl acrylate and 21.4 g of methyl methacrylate) was dropped in 30 min. and the reaction was further continued for 3 hrs. Then, the reaction mixture was cooled to 30° C. and filtered to obtain a modified aqueous-dispersible polyester solution B-2 (18% by weight solids).

Preparation of Modified Aqueous-dispersible Polyester Solution B-3

To a 3 liter three-necked flask provided with a stirring blade, a reflux condenser, a thermometer and a dropping funnel was added 1900 ml of a 15% by weight aqueous-dispersible polyester A-1 solution and the internal temperature was raised to 80° C. Further thereto was added 6.52 ml of an aqueous 24% ammonium peroxide solution and a monomer mixture solution (containing 10.7 g of styrene, 28.5 g of glycidyl methacrylate, 21.4 g of ethyl acrylate and 10.7 g of methyl methacrylate) was dropped in 30 min. and the reaction was further continued for 3 hrs. Then, the reaction mixture was cooled to 30° C. and filtered to obtain a modified aqueous-dispersible polyester solution B-3 (18% by weight solids).

Preparation of Modified Aqueous-dispersible Polyester Solution B-5

To a 3 liter three-necked flask provided with a stirring blade, a reflux condenser, a thermometer and a dropping funnel was added 1900 ml of a 15% by weight aqueous-dispersible polyester A-1 solution and the internal temperature was raised to 80° C. Further thereto was added 6.52 ml of an aqueous 24% ammonium peroxide solution and a monomer mixture solution (containing 28.5 g of styrene, 28.5g of glycidyl methacrylateand 14.3 g of acrylamide) was dropped in 30 min. and the reaction was further continued for 3 hrs. Then, the reaction mixture was cooled to 30° C. and filtered to obtain a modified aqueous-dispersible polyester solution B-3 (18% by weight solids).

Preparation of Acryl Type Polymer Latex C-1 through C-4

Acryl type polymer latexes having the following monomer composition C-1 to C-4 were prepared through emulsion polymerization. The solid contents were each 30% solids.

TABLE 1

| Latex No. | Monomer Composition |
|---|---|
| C-1 | styrene:glycidyl methacrylate:n-butyl acrylate = 20:40:40 |
| C-2 | styrene:n-butyl acrylate:t- |
| | butylacrylate:hydroxyethylacrylate = 27:10:35:28 |
| C-3 | styrene:butyl acrylate:acetoacetoxyethyl methacrylate = |
| | 40:40:20 |
| C-4 | ethyl acrylate:methyl methacrylate = 50:50 |

Preparation of Subbed Support

Both sides of biaxially stretched polyethylene terephthalate film were subjected to corona discharge treatment at 12 W/m²-min. On one side thereof, coating solution b-1 for the backing-side lower sublayer was coated so as to form a dry thickness of 0.06 μm and dried at 140° C., and further thereon, coating solution b-2 for the backing-side upper sublayer was coated so as to form a dry thickness of 0.01 μm and dried at 140° C. On the opposite side, coating solution a-1 for the imaging layer-side lower sublayer was coated so as to form a dry thickness of 0.2 μm and dried at 140° C., and further thereon, coating solution a-2 for the imaging layer-side upper sublayer was coated so as to form a dry thickness of 0.03 μm and dried at 140° C. The thus sub-coated support was subjected to thermal treatment at 125° C. for 2 min. to obtain subbed support 1.

Coating solution b-1 for back side lower sublayer

| | | |
|---|---|---|
| Acryl type polymer latex C-1 (30% solids) | 15.0 | g |
| Acryl type polymer latex C-2 (30% solids) | 3.8 | g |
| SnO₂ sol (10% solids) | 90 | g |
| Surfactant (A) | 0.5 | g |
| Water to make | 1000 | ml |

* SnO₂ sol which was prepared in accordance with the
method described in JP-B 35-6616 was concentrated so as to
have 10% solids and the pH was adjusted to 10 with aqueous
ammonia

Coating solution b-2 for back side upper sublayer

| | | |
|---|---|---|
| Modified aqueous-dispersible polyester B-1 (18% solids) | 108.0 | g |
| Surfactant (A) | 0.1 | g |
| Fine silica particles (av. size of 2 μm) | 0.3 | g |
| Water to make | 1000 | ml |

Coating solution a-1 for imaging layer-side lower sublayer

| | | |
|---|---|---|
| Acryl type polymer latex C-1 (30% solids) | 70.0 | g |
| Acryl type polymer latex C-2 (30% solids) | 3.7 | g |
| Surfactant (A) | 0.1 | g |
| Water to make | 1000 | ml |

Coating solution a-2 for imaging layer-side upper sublayer

| | | |
|---|---|---|
| Polyvinyl alcohol (PVA-235, available from | 3.0 | g |
| KURARAY CO., LTD.) | | |
| Surfactant (A) | 0.1 | g |
| Fine silica particles (av. size of 2 μm) | 0.3 | g |
| Water to make | 1000 | ml |

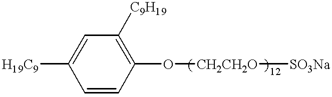

Preparation of Photothermographic Material Sample 1

On the foregoing subbed support 1 were coated a backing layer, image forming layer and surface-protective layer to prepare photothermographic material sample No. 1.

Solvent-based Backing Layer Coating

To 830 g of methyl ethyl ketone (hereinafter, also denoted as MEK), 84.2 g of cellulose acetate-butylate (CAB381-20, available from Eastman Chemical Co.) and 4.5 g of polyester resin (Vitel PE2200B, available from Bostic Corp.) were added with stirring and dissolved therein. To the resulting solution was added 0.30 g of infrared dye-1 and 4.5 g fluorinated surfactant (Surflon KH40, available from ASAHI Glass Co. Ltd.) and 2.3 g fluorinated surfactant (Megafag F120K, available from DAINIPPON INK Co. Ltd.) which were dissolved in 43.2 g methanol, were added thereto and stirred until being dissolved. Then, 75 g of silica (Siloid 64×6000, available from W.R. Grace Corp.), which was dispersed in methyl ethyl ketone in a concentration of 1 wt % using a dissolver type homogenizer, was further added thereto with stirring to obtain a coating solution A for backing layer.

Infrared dye-1

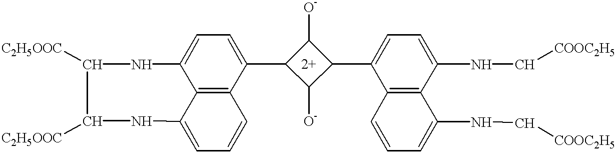

The thus prepared coating solution for a backing layer was coated on the back side of the foregoing subbed support 1 by an extrusion coater and dried so as to have dry thickness of 3.5 μm. Drying was carried out at a dry-bulb temperature of 100° C. and a wet-bulb temperature of 10° C. over a period of 5 min.

Preparation of Light-sensitive Silver Halide Emulsion A

| | | |
|---|---|---|
| Solution A1 | | |
| Phenylcarbamoyl gelatin | 88.3 | g |
| Compound (A) (10% methanol solution) | 10 | ml |
| Potassium bromide | 0.32 | g |
| Water to make | 5429 | ml |
| Solution B1 | | |
| 0.67 mol/l Aqueous silver nitrate solution | 2635 | ml |
| Solution C1 | | |
| Potassium bromide | 51.55 | g |
| Potassium iodide | 1.47 | g |
| Water to make | 660 | ml |
| Solution D1 | | |
| Potassium bromide | 154.9 | g |
| Potassium iodide | 4.41 | g |
| Iridium chloride (1% solution) | 0.93 | ml |
| Water to make | 1982 | ml |
| Solution E1 | | |

| | |
|---|---|
| 0.4 mol/l aqueous potassium bromide | Amount |
| solution | necessary to adjust |
| | silver potential |

| | | |
|---|---|---|
| Solution F1 | | |
| Potassium hydroxide | 0.71 | g |
| Water to make | 20 | ml |
| Solution G1 | | |
| Aqueous 56% acetic acid solution | 18 | ml |
| Solution H1 | | |
| Anhydrous sodium carbonate | 1.72 | g |
| Water to make | 151 | ml |

Compound (A): HO(CH₂CH₂O)ₙ—(CH(CH₃)CH₂O)₁₇—(CH₂CH₂O)ₘH (m + n = 5 to 7)

Using a stirring mixer described in JP-B 58-58288 and 58-58289, 1/4 of solution B1, the total amount of solution C1 were added to solution A1 by the double jet addition for 4 min 45 sec. to form nucleus grain, while maintaining a temperature of 45° C. and a pAg of 8.09. After 1 min., the total amount of solution Fl was added thereto. After 6 min, 3/4 of solution B1 and the total amount of solution D1 were further added by the double jet addition for 14 min 15 sec., while mainlining a temperature of 45° C. and a pAg of 8.09. After stirring for 5 min., the reaction mixture was lowered to 40° C. and solution G1 was added thereto to coagulate the resulting silver halide emulsion. Remaining 2000 ml of precipitates, the supernatant was removed and after adding 10 lit. water with stirring, the silver halide emulsion was again coagulated. Remaining 1500 ml of precipitates, the supernatant was removed and after adding 10 lit. water with stirring, the silver halide emulsion was again coagulated. Remaining 1500 ml of precipitates, the supernatant was removed and solution H1 was added. The temperature was raised to 60° c. and stirring continued for 120 min. Finally, the pH was adjusted to 5.8 and water was added there to so that the weight per mol of silver was 1161 g, and light-sensitive silver halide emulsion A was thus obtained. It was proved that the resulting emulsion was comprised of monodisperse silver iodobromide cubic grains having an average grain size of 0.058 μm, a coefficient of variation of grain size of 12% and a [100] face proportion of 92%.

Preparation of Powdery Organic Silver Salt A

In 4720 ml water were dissolved 130.8 g of behenic acid, 67.7 g of arachidic acid, 43.6 g of stearic acid and 2.3 g of palmitic acid at 80° C. The, after adding 540.2 ml of 1.5M aqueous sodium hydroxide solution with stirring and further adding 6.9 ml of concentrated nitric acid, the solution was cooled to a temperature of 55° C. to obtain an aqueous organic acid sodium salt solution. To the solution were added the silver halide emulsion obtained above (equivalent to 0.038 mol silver) and 450 ml water and stirring further continued for 5 min., while maintained at a temperature of 55° C. Subsequently, 760 ml of IM aqueous silver nitrate solution was added in 2 min. and stirring continued further for 20 min., then, the reaction mixture was filtered to remove aqueous soluble salts. Thereafter, washing with deionized water and filtration were repeated until the filtrate reached a conductivity of 2 μS/cm.

Using a flush jet dryer (produced by Seishin Kigyo Co., Ltd.), the thus obtained cake-like organic silver salt was dried under an atmosphere of inert gas (i.e., nitrogen gas) having a volume ratio shown in Table 1, according to the operation condition of a hot air temperature at the inlet of the dryer until reached a moisture content of 0.1%. The moisture content was measured by an infrared ray aquameter.

Preparation of Pre-dispersion A

In 1457 g MEK was dissolved 14.57 g of polyvinyl butyral powder (Butvar B-79, available from Monsanto Corp.) and further thereto was gradually added 500 g of the powdery organic silver salt to obtain pre-dispersion A, while stirring by a dissolver type homogenizer (DISPERMAT Type CA-40, available from VMA-GETZMANN).

Preparation of Light-sensitive Emulsion 1

Thereafter, using a pump, the pre-dispersion A was transferred to a media type dispersion machine (DISPERMAT Type SL-C12 EX, available from VMA-GETZMANN), which was packed 1 mm Zirconia beads (TORESELAM, available from Toray Co. Ltd.) by 80%, and dispersed at a circumferential speed of 8 m/s and for 1.5 min. of a retention time with a mill to obtain light-sensitive emulsion 1.

Preparation of Stabilizer Solution

In 4.97 g methanol were dissolved 1.0 g of Stabilizer-1 and 0.31 g of potassium acetate to obtain stabilizer solution.

Preparation of Infrared Sensitizing Dye Solution A

In 31.3 ml MEK were dissolved 19.2 mg of infrared sensitizing dye (SD-1), 1.488 g of 2-chlorobenzoic acid, 2.779 g of Stabilizer-2 and 365 mg of 5-methyl-2-mercaptobenzimidazole in a dark room to obtain an infrared sensitizing dye solution A.

Preparation of Additive Solution a

In 110 g MEK were dissolved 27.98 g of developer 1,1-bis(2-hydroxy-3,5-dimethylphenyl)-2-methylpropane, 1.54 g of 4-methylphthalic acid and 0.48 g of the infrared dye-1 to obtain additive solution a.

Preparation of Additive Solution b

Antifoggants-2 of 3.56 g and 3.43 g of phthalazine were dissolved in 40.9 g MEK to obtain additive solution b.

Stabilizer-1

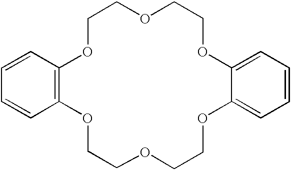

Infrared Sensitizing Dye 1

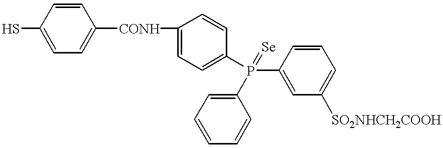

Stabilizer-2

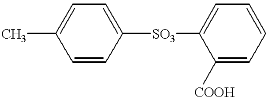

Antifogganr-2

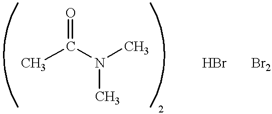

Preparation of Image Forming Layer Coating Solution

Under inert gas atmosphere (97% nitrogen), 50 g of the light-sensitive emulsion 1 and 15.11 g MEK were maintained at 21° C. with stirring, 1000 μl of chemical sensitizer S-5 (10% methanol solution) was added thereto and after 2 min., 390 μm of antifoggant-2 (10% methanol solution) was added and stirred for 1 hr. Further thereto, 494 μm of calcium bromide (10% methanol solution) was added and after stirring for 10 min., gold sensitizer Au-5 of 1/20 equimolar amount of the chemical sensitizer was added and stirred for 20 min. Subsequently, 167 ml of the stabilizer solution was added and after stirring for 10 min., 1.32 g of the infrared sensitizing dye solution A was added and stirred for 1 hr. Then, the mixture was cooled to 13° C. and stirred for 30 min. Further thereto, 13.31 g of polyvinyl butyral (Butvar B-79, available from Monsant Co.) was added and stirred for 30 min, while maintaining the temperature at 13° C., and 1.084 g of tetrachlorophthalic acid (9.4% MEK solution) and stirred for 15 min. Then, 12.43 g of additive solution a, 1.6 ml of 10% MEK solution of Desmodur N3300 (aliphatic isocyanate, product by Movey Co.) and 4.27 g of the foregoing additive solution b were successively added with stirring to obtain a coating solution of the image forming layer.

Preparation of Matting Agent Solution

In 42.5 g MEK was dissolved cellulose acetate-butyrate (CAB 171-15, available from Eastman Chemical Co.) and further thereto, 5 g of calcium carbonate (Super-Pflex 200, available from Special Minerals Co.) was added and dispersed using a dissolver type homogenizer at 8000 rpm for 30 min. to obtain a matting agent dispersion.

Preparation of Surface Protective Layer Coating Solution

In 865 g MEK were dissolved with stirring 96 g of cellulose acetate-butyrate (CAV 171-15), 4.5 g of polymethyl methacrylic acid (Paraloid A-21, Rohm & Haas Co.). 4.5 g of vinylsulfone compound, 1.0 g of benztriazole and 1.0 g of fluorinated surfactant (Surflon KH 40) Then, 30 g of the matting agent dispersion was added with stirring to obtain a coating solution of the surface protective layer.

S-5

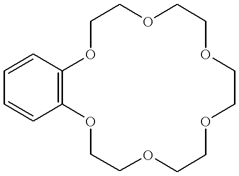

Au-5

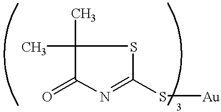

Antifoggant-1

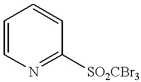

VSC

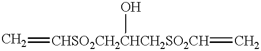

Coating of Image Forming Layer and Protective Layer

Coating solutions of the image forming layer and surface protective layer were simultaneously coated using a extrusion type coater to prepare photothermographic material Sample No.1. Coating was carried out so as to form an image forming layer having a silver coverage of 1.9 g/m² and a protective layer having a dry thickness of 2.5 μm, and drying was carried out using hot air at a dry bulb temperature of 75° C. and a dew point of 10° C.

Preparation of Photothermographic Material Sample No. 2 to 21

Photothermographic material Samples Nos. 2 to 21 were prepared similarly to Sample No. 1, except that the lower sublayer of the backing layer side was varied with respect to kind and mixing ratio of binders, additive and dry layer thickness, as shown in Table 2.

Preparation of Photothermographic Material Sample No. 22

Photothermographic material Samples Nos. 22 was prepared similarly to Sample No. 1, except that the upper and lower sublayers of the backing layer side were not provided.

Preparation of Photothermographic Material Sample No. 23 to 26

Photothermographic material Samples Nos. 23 to 26 were prepared similarly to Sample No. 1, except that the lower sublayer of the backing layer side was varied with respect to kind and mixing ratio of binders, additive and dry layer thickness, as shown in Table 2, and the solvent-based backing layer was replaced by a water-based backing layer.

Coating of Water-based Backing Layer

Preparation of Water-based Backing Layer Coating Solution

To 30 g of polyvinyl alcohol were added 50 g of a color forming agent dispersion prepared according to the following procedure, 20 g of compound (D), 250 g of water and 1.8 g of Sildex H121 (spherical silica of an average particle size of 12 μm, available from DOKAI KAGAKU Co., Ltd.) to prepare a water-based backing layer coating solution.

Preparation of Color Forming Agent Dispersion

In 35 g of ethyl acetate were dissolved 2.5 g of compound (B) and 7.5 g of compound (C) with stirring. Further thereto was added 50 g of a previously dissolved 10 wt % polyvinyl alcohol solution and the mixture was stirred for 5 min. Thereafter, ethyl acetate was evaporated through desolvation, and finally, diluting with water, a color forming agent dispersion was prepared.

Compound (B)

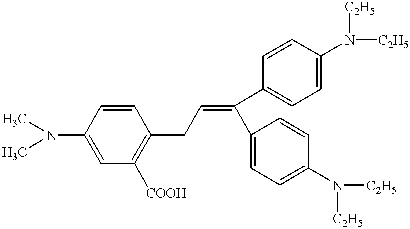

Compound (C)

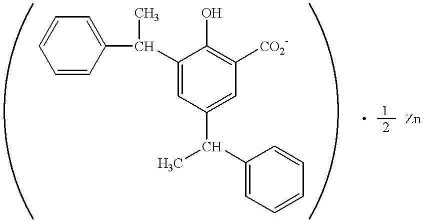

Compound (D)

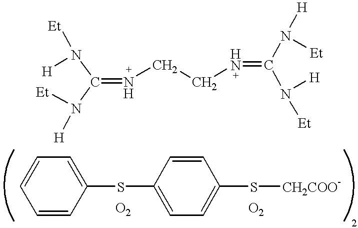

On the upper sublayer of the backing layer-side of each support, the foregoing water-based backing layer coating solution was coated by a slide bead system so as to form a layer exhibiting an optical density at 660 nm of 0.7 and after being maintained at 10° C. for 1 min., drying was carried out at 35° C. for 5 min.

Preparation of Photothermographic Material Sample No. 27

Sample No. 27 was prepared similarly to Sample No. 23,except that the lower and upper sublayers of the backing layer-side were not provided.

Preparation of Photothermographic Material Sample No. 28

Sample No. 28 was prepared, in which the first and second sublayers were coated in accordance with Examples in JP-A 5-34856.

TABLE 2

| | Presence | | | | Additive to Upper | | Dry Thickness | | |
|---|---|---|---|---|---|---|---|---|---|
| Sample | of | Sublayer Binder | | | Sublayer | | of Upper | Backing | |
| No. | Sublayer | 1 | 2 | Mix. Ratio | Compound | Solids % | Sublayer (μm) | Layer | Remark |
| 1 | Yes | B-1 | — | 100:0 | — | — | 0.10 | S*¹ | Inv. |
| 2 | Yes | B-1 | C-2 | 90:10 | — | — | 0.10 | S | Inv. |
| 3 | Yes | B-1 | — | 100:0 | — | — | 0.20 | S | Inv. |
| 4 | Yes | B-2 | — | 100:0 | — | — | 0.20 | S | Inv. |
| 5 | Yes | B-1 | — | 100:0 | P-1 | 10% | 0.20 | S | Inv. |
| 6 | Yes | B-1 | — | 100:0 | F-1 | 2% | 0.20 | S | Inv. |
| 7 | Yes | B-1 | — | 100:0 | F-1 | 5% | 0.20 | S | Inv. |
| 8 | Yes | B-2 | — | 100:0 | F-2 | 5% | 0.20 | S | Inv. |
| 9 | Yes | B-3 | — | 100:0 | — | — | 0.20 | S | Inv. |
| 10 | Yes | B-1 | A-1 | 90:10 | — | — | 0.20 | S | Inv. |
| 11 | Yes | B-5 | — | 100:0 | — | — | 0.20 | S | Inv. |
| 12 | Yes | A-1 | C-2 | 80:20 | — | — | 0.20 | S | Inv. |
| 13 | Yes | A-1 | C-2 | 80:20 | — | — | 0.40 | S | Inv. |
| 14 | Yes | A-1 | C-4 | 80:20 | — | — | 0.20 | S | Inv. |
| 15 | Yes | A-1 | — | 100:0 | — | — | 0.20 | S | Comp. |
| 16 | Yes | C-2 | — | 100:0 | — | — | 0.20 | S | Comp. |
| 17 | Yes | D-1 | C-2 | 80:20 | — | — | 0.20 | S | Inv. |
| 18 | Yes | D-2 | C-2 | 80:20 | — | — | 0.20 | S | Inv. |
| 19 | Yes | D-1 | — | 100:0 | — | — | 0.20 | S | Comp. |
| 20 | Yes | E-1 | C-2 | 80:20 | — | — | 0.20 | S | Inv. |
| 21 | Yes | E-1 | — | 100:0 | — | — | 0.20 | S | Comp. |
| 22 | No | — | — | — | — | — | — | S | Comp. |
| 23 | Yes | B-1 | — | 100:0 | — | — | 0.20 | W*² | Inv. |
| 24 | Yes | B-2 | — | 100:0 | — | — | 0.20 | W | Inv. |
| 25 | Yes | B-2 | — | 100:0 | — | — | 0.40 | W | Inv. |
| 26 | Yes | A-1 | — | 100:0 | — | — | 0.20 | W | Comp. |
| 27 | No | — | — | — | — | — | — | W | Comp. |
| 28 | Yes(*³) | Gelatin | — | 100:0 | — | — | 0.16 | S | Comp. |

*¹S: Solvent-based, *²W: Water-based
*³Lower layer binder: styrene-butadiene copolymer, dry lower layer thickness of 0.16 μm

In Table 2, the solids percentage of an additive indicates percentage by volume of additive solids, based on a total solids content in the upper sublayer of the backing layer side and other designations are as follows:

P-1: Plasticizer D110 (available from TOYO PETRILITE Co., Ltd.)

F-1: Filler SnO₂ sol (synthesized according to the method described in JP-A 10-59720

F-2: Filler colloidal silica (RUDOX AM, available from Du Pont Co.)

D-1: Aqueous polyurethane (W-6015, available from Takeda Chemical Industries, Ltd.)

D-2: Aqueous polyurethane (W-7004, available from Takeda Chemical Industries, Ltd.)

E-1: Aqueous methylcellulose (SM-15, available from Shi-Etsu Chemical Co., Ltd.)

Evaluation of Photothermographic Material

Photothermographic material Samples 1 through 27 were each evaluated with respect to the following characteristics in accordance with the procedure described below.

Exposure and Processing

Samples were each exposed using an imager provided with a 810 nm semiconductor laser. Then, samples were thermally processed at a temperature of 110° C. for 15 sec. using a thermal processor provided with a heated drum. Exposure and processing were conducted in the room maintained at 23° C. and 50% RH.

Tape-stripping Adhesion Test

Onto the backing layer side of each sample before or after subjected to thermal processing (i.e., unprocessed or processed sample), a cellophane adhesive tape (product by NICHIBAN CO., LTD.) was adhered and rapidly stripped at an acute angle. An stripped area of the backing layer was measured and evaluated based on the following criteria:

1: adhesion is very weak and the backing layer is completely stripped,

2: a stripped area of not less than 50% and less than 100%,

3: a stripped area of not less than 20% and less than 50%,

4: adhesion is strong and a stripped area of not less 5% and less than 20%,

5: adhesion is very strong and a stripped area of less than 5%.

Rank 4 or more is a level acceptable in practical use.

Scratch Resistance

Scratch resistance was evaluated for the backing layer side of a subbed support and a sample further coated thereon with a backing layer of each photothermographic material sample, according to the following manner.

Samples were allowed to stand in an atmosphere of 23° C. and 55% RH for 24 hrs. Thereafter, a sapphire needle having a curvature radium of 0.15 mm on its top was placed vertically onto the sample and moved at a speed of 60 cm/min, while the load on the sapphire needle was gradually varied from 0 g to 200 g. With regard to the subbed support, the load when scratches reached the support (denoted as Subbed Sample) and with regard to the backing layer-coated sample, the load when scratches reached the interface between the backing layer and sublayer were each defined as a measure of scratch resistance (denoted as Backing Sample). The more value indicates the higher scratch resistance. In this case, 100 g or more is acceptable levels for practical use.

Pencil Scratch Test

Backing layer-coated samples were each subjected to the pencil hardness test on a hot plate heated at 120° C., based on JIS k5400. Thus, a sample was placed, with a backing layer upward, on a heated plate at 120° C. and when a pencil was allowed to move at an angle of 45° on the sample surface, rupture of the backing layer was evaluated as pencil scratch value, based on the method of JIS k5400. The evaluation bases are 9H, 8H, 7H, 6H, 5H, 4H, 3H, 2H, H, F, HB, B, 2B, 3B, 4B, 5B and 6B in the order of decreasing in hardness. 2H or more are acceptable levels for practical use.

Evaluation of Dmin

Photothermographic material samples were each cut to sheets of a size of 5 cm×20 cm and two parts for each sample were prepared, in which three sheets were superposed for each part. One part of the samples was allowed to stand at a temperature of 23° C. and 50% RH for 3 days and the other part was allowed to stand at 55° C. and 50% RH for 3 days, while the unexposed image forming layer side was upwardly placed and further thereon, a load of 5 g/cm² was loaded. Similarly, photothermographic material samples were allowed to stand at 55° C. for 3 days. The thus aged samples were thermally developed and the density of the unexposed area (also denoted as Dmin) was measured with respect to transmission density at the wavelength of 400 nm, using spectrophotometer UV-1200 (available from Shimadzu Corp.). The difference in Dmin between a sample aged at room temperature and sample aged at 55° C. (i.e., Dmin at 55° C. minus Dmin at 23° C.) was determined as ADmin. ADmin of 0.02 or less is acceptable levels in practical use and ADmin of 0.05 or more is unacceptable in practical use.

Results of the foregoing are shown in Table 3.

TABLE 3

| | | Adhesion | | | | | |
|---|---|---|---|---|---|---|---|
| Sam- | | Unpro- | Pro- | Scratch Resistance (g) | | Pencil | |
| ple | | cessed | cessed | Subbed | Backing | Scratch | |
| No. | ΔDmin | Sample | Sample | Sample | Sample | Test | Remark |
| 1 | 0.01 | 5 | 4 | 180 | 130 | 2H | Inv. |
| 2 | 0.01 | 5 | 4 | 170 | 120 | 2H | Inv. |
| 3 | 0.01 | 5 | 5 | 160 | 180 | 2H | Inv. |
| 4 | 0.01 | 5 | 5 | 155 | 175 | 2H | Inv. |
| 5 | 0.02 | 5 | 5 | more than 200 | 140 | 2H | Inv. |
| 6 | 0.01 | 5 | 5 | 135 | 120 | 3H | Inv. |
| 7 | 0.01 | 5 | 5 | 110 | 105 | 4H | Inv. |
| 8 | 0.02 | 5 | 5 | 115 | 110 | 4H | Inv. |
| 9 | 0.01 | 5 | 5 | 180 | 175 | 2H | Inv. |
| 10 | 0.01 | 5 | 4 | more than 200 | 160 | 2H | Inv. |
| 11 | 0.01 | 4 | 4 | 140 | 150 | 2H | Inv. |
| 12 | 0.01 | 5 | 4 | 120 | 155 | 2H | Inv. |
| 13 | 0.02 | 5 | 4 | 115 | 160 | 2H | Inv. |
| 14 | 0.01 | 5 | 4 | 120 | 170 | 2H | Inv. |
| 15 | 0.01 | 3 | 2 | 120 | 70 | H | Comp. |
| 16 | 0.01 | 5 | 5 | 75 | 180 | 2H | Comp. |
| 17 | 0.01 | 5 | 4 | 130 | 140 | 2H | Inv. |
| 18 | 0.01 | 4 | 4 | 140 | 120 | 2H | Inv. |
| 19 | 0.01 | 2 | 2 | 110 | 75 | H | Comp. |
| 20 | 0.01 | 4 | 4 | 105 | 120 | 2H | Inv. |
| 21 | 0.01 | 2 | 1 | 110 | 60 | H | Comp. |
| 22 | 0.01 | 2 | 1 | — | 55 | H | Comp. |
| 23 | 0.01 | 5 | 5 | 160 | 180 | 2H | Inv. |
| 24 | 0.01 | 5 | 5 | 155 | 175 | 2H | Inv. |
| 25 | 0.02 | 5 | 5 | 140 | 190 | 2H | Inv. |
| 26 | 0.02 | 3 | 3 | 120 | 80 | 2H | Comp. |
| 27 | 0.01 | 1 | 1 | — | 40 | F | Comp. |
| 28 | 0.06 | 2 | 1 | 110 | 50 | F | Comp. |

As apparaent from Table 3, photothermographic material samples having a sublayer relating to the invention exhibited superior image performance and improved adhesion property of the backing layer before or even after subjected to thermal processing. It was further proved that the support having a sublayer of the invention and the support further coated with a backing layer, which were used in the photothermographic material samples, exhibited relatively high scratch resistance.

What is claimed is:

1. A photothermographic material comprising a support having thereon at least an image forming layer and a first layer on the opposite side of the support from the image forming layer, wherein the first layer contains a vinyl type polymer latex and an aqueous-dispersible polymer selected from the group consisting of an aqueous-dispersible polyester, aqueous-dispersible polyurethane and aqueous-dispersible cellulose.

2. The photothermographic material of claim 1, wherein the aqueous-dispersible polymer is an aqueous-dispersible polyester.

3. The photothermographic material of claim 2, wherein the first layer is a sublayer, the photothermographic material further comprising a backing layer on the first layer.

4. The photothermographic material of claim 2, wherein the aqueous-dispersible polyester comprises a dicarboxylic acid monomer unit having at least one sulfonic acid group.

5. The photothermographic material of claim 4, wherein the dicarboxylic acid monomer unit having at least one sulfonic acid group is contained in an amount of 5 to 15 mol %, based on total dicarboxylic acid monomer unit.

6. The photothermographic material of claim 2, wherein the aqueous-dispersible polymer is contained in a ratio by weight of the aqueous-dispersible polymer/vinyl type monomer constituting the vinyl type polymer latex of 99/1 to 5/95.

7. The photothermographic material of claim 3, wherein the backing layer contains cellulose acetate butyrate.

8. The photothermographic material of claim 3, wherein the aqueous polyester comprises said dicarboxylic acid monomer unit having at least one sulfonic acid group of 5 to 15 mol %, based on total dicarboxylic acid monomer unit; the aqueous-dispersible polymer being contained in a ratio by weight of the aqueous-dispersible polymer/vinyl type monomer constituting the vinyl type polymer latex of 95/5 to 80/20.

9. A photothermographic material comprising a polyester support having thereon at least an image forming layer and a first layer on the opposite side of the support from the image forming layer, wherein the first layer is formed by coating a composition obtained through latex polymerization of a vinyl type monomer in the presence of an aqueous-dispersible polymer selected from the group consisting of an aqueous-dispersible polyester, aqueous-dispersible polyurethane and aqueous-dispersible cellulose.

10. The photothermographic material of claim 9, wherein the aqueous-dispersible polymer is an aqueous-dispersible polyester.

11. The photothermographic material of claim 10, wherein the first layer is a sublayer, the photothermographic material further comprising a backing layer on the first layer.

12. The photothermographic material of claim 12, wherein the aqueous-dispersible polyester comprises a dicarboxylic acid monomer unit having at least one sulfonic acid group.

13. The photothermographic material of claim 12, wherein the dicarboxylic acid monomer unit having at least one sulfonic acid group is contained in an amount of 5 to 15 mol %, based on total dicarboxylic acid monomer unit.

14. The photothermographic material of claim 10, wherein the aqueous-dispersible polymer is contained in a ratio by weight of the aqueous-dispersible polymer/vinyl type monomer constituting the vinyl type polymer latex of 99/1 to 5/95.

15. The photothermographic material of claim 11, wherein the backing layer contains cellulose acetate butyrate.

16. The photothermographic material of claim 11, wherein the aqueous polyester comprises said dicarboxylic acid monomer unit having at least one sulfonic acid group of 5 to 15 mol %, based on total dicarboxylic acid monomer unit; the aqueous-dispersible polymer being contained in a ratio by weight of the aqueous-dispersible polymer/vinyl type monomer constituting the vinyl type polymer latex of 95/5 to 80/20.
